(19) United States
(12) Patent Application Publication
(10) Pub. No.: US 2010/0166597 A1
(43) Pub. Date: Jul. 1, 2010

(54) Device for Treating a Gaseous Effluent Loaded with Odorant Compounds using a Three-Dimensional Mesh, Corresponding Installation and Process

(76) Inventors: Celia Sanchez, Rennes (FR); Annabelle Couvert, Rennes (FR); Christophe Renner, Gagny (FR)

Correspondence Address: COATS & BENNETT, PLLC, 1400 Crescent Green, Suite 300, Cary, NC, 27518, US

(21) Appl. No.: 12/095,534

(22) PCT Filed: Nov. 30, 2006
(86) PCT No.: PCT/EP06/69143

§ 371 Date: Sep. 16, 2008

(30) Foreign Application Priority Data
Dec. 2, 2005 (FR) 0512273
Nov. 30, 2006 (EP) PCT/EP2006/069143

(51) Int. Cl. B01D 53/78; B01D 53/34; B01D 53/18; B01J 19/32; B01J 10/00

(52) U.S. Cl. 422/4; 422/180

(57) ABSTRACT

The invention relates to a device for treating a gaseous effluent loaded with odorant compounds, comprising a reactor (1) through which said effluent can pass in transit in the presence of a washing solution, characterized in that said reactor (1) integrates a three-dimensional mesh (14) capable of promoting interfacial exchanges between said effluent and said washing solution.

The field of the invention is that of deodorization of gaseous effluents. More specifically, the invention relates to a technique for deodorization of a gaseous effluent using a reactor in which the effluent passes through in the presence of a wash solution.

Currently, the removal of odiferous compounds from the air is conventionally done by chemical washes based on acids, bases and/or oxidants, in vertical or horizontal columns that may or may not be equipped with a packing material.

Even if the treatment method has until now provided good results in terms of efficacy, there remains a problem of operating costs, and in particular a concern associated with the coverage area which no one has yet managed to solve.

Indeed, the contact time necessary for an effective treatment with this type of installation (greater than the second, given the area of gas-liquid interfacial exchange generated) has led to the construction of large structures, namely towers several meters high, involving high material and civil engineering costs.

Another solution has been studied, using static mixers, for example, to remove hydrogen sulfide (Péculier, 1996) and has led to the production of odiferous gas treatment units.

Static mixers are conventionally used to enhance liquid/liquid mixtures or the dispersion of gases in liquids (predominantly liquid phase). They are used, for example, in the chemical industry (dilution of solvents, emulsion of non-miscible liquids, etc.), the oil industry (mixture of gasoline with various indices, additive and fuel mixture, etc.), the paper industry (bleaching), the food industry (addition of coloring agents, emulsifiers) or water treatment (rapid mixture of flocculation additive).

In the context of a gas/liquid use, the liquid phase is usually the predominant phase with respect to the gas phase, which is the minority phase (i.e. oxygenation of water by injecting air).

The main advantages of static mixers are the following:
low maintenance due to the absence of moving mechanical parts;
low bulk;
good standardization due to good macro- and micro-mixing (generally no dead zone);
high range of working rates;
wide range of fluid viscosities;
intense heat and material exchange;
easy operation.

However, the major disadvantage of these diphasic contactors lies in the high head losses that they generate (capable of being 100 times greater than that observed in packed columns). This head loss makes it necessary to implement higher ventilation powers, thus increasing the operating costs, and makes these contactors incompatible in numerous industrial gas treatment applications.

In particular, a static mixture including helical elements with three blades is known. Radial serrations on the faces of the hub of each element make it possible to adjust to the position most suitable for the laminar, turbulent or intermediate flow. The assembly of seven elements forms an impeller causing a 180° rotation of the fluid.

A static mixture including helical elements placed in a 90° sequence, each repeatedly dividing the flow so as to obtain a homogeneous mixture after several elements is also known.

According to another type of static mixer, helical elements divide the fluid into a series of sequential or alternating 180° rotations.

According to yet another type of static mixer, waffled plates superimposed in layers form open channels that intersect, with the next element being arranged at 90° with respect to the previous one. This internal packing comprises inclined blades and divides the flow into a multitude of small layers, recombines them and re-divides them, thus creating the fluid mixture.

Regardless of the static mixers known, the high head losses generated by the mixing and/or transfer components have always constituted a technological impediment. Therefore, few researchers have looked into an industrial use other than for mixing fluids, and have much less attempted to reduce these head losses in order to optimize their operation.

It therefore seemed necessary to attempt to solve these head loss problems while preserving the benefits of the compactness of the system, or of finding a new solution preserving the advantages of static mixers without having the disadvantages.

The invention is intended in particular to overcome the disadvantages of the prior art.

More specifically, the invention is intended to propose a technique for treating odiferous gases combining the advantages of packed columns and static mixers, i.e. a method with low head losses and high odiferous compound removal efficiency.

The invention is also intended to provide such a technique with a low bulk by comparison with the prior art solutions.

The invention is also intended to provide such a technique making it possible to envisage a reduction in operating costs with respect to the costs of known techniques.

Another objective of the invention is to provide such a technique with a simple design and that is easy to implement.

These objectives, as well as others that will appear below, are achieved by the invention, which relates to a device for treating a gaseous effluent containing odiferous compounds, including a reactor through which said effluent is capable of passing in the presence of a wash solution, characterized in that said reactor includes a three-dimensional mesh designed to promote areas of interfacial exchange between said effluent and said wash solution.

Thus, the invention proposes a more “airy” structure than static mixers. The impact of fluids circulating through the mesh causes strong turbulence. However, it does not cause high head losses due to the low contact surface opposite their flow.

This structure makes it possible to divide the flows into a plurality of partial currents, and then to re-mix them. By changing the speed profiles (divisions and sequential recombination's of the flow), this structure makes it possible to redistribute the flows within the casing, generating a strong turbulence, a good mixture and improving the interfacial exchange area.

This interfacial area is a key parameter insofar as it affects the transfer of pollutants from the gas phase to the reactive liquid phase where they will be eliminated. The transfer coefficients are high, as is the turbulence, due to strong mixing.

The invention therefore makes it possible to overcome the technological impediment of the high head losses generated by static mixers.

The improvement of head losses, by comparison with air treatment systems conventionally used, makes it possible to use less powerful fans, which leads to a significant reduction in operating costs; energy consumption is indeed a major financial item in deodorization units (on the order of 20% of the operating costs).

By comparison with the washing columns of the prior art, a device according to the invention can be produced very compactly, thereby making it a system that can be used more easily.

On an industrial site with a plurality of odiferous gaseous emission sources, it can, for example, be installed at each site where odors are to be treated, thus avoiding an entire network of ventilation ducts necessary for sending the contaminated air to a central treatment unit such as the washing columns. The gain in terms of equipment costs is thus substantial, due to the reduction in the area of coverage of ventilation ducts.

According to an advantageous solution, said three-dimensional mesh includes a plurality of strands mounted so as to be essentially stationary in said reactor.

In this case, at least some of said strands are preferably semi-rigid.

A mesh is thus obtained with a relative flexibility that tends to further reduce head losses.

Therefore, by the term “essentially stationary”, we mean that the strands are mounted securely on the walls of the reactor, but that they can bend slightly under the effect of the flow of gas and/or wash solution.

Preferably, said strands have a circular cross-section with a diameter between 0.5 mm and 4 mm.

According to an advantageous solution, said three-dimensional mesh has meshes of which the sides have a length between around 1 cm and around 10 cm, and preferably between around 1 cm and around 3 cm.

Advantageously, said device includes means for co-current injection of said effluent and said wash solution.

According to a first embodiment, said reactor extends according to a substantially vertical axis.

In this case, according to a first alternative, said effluent and said wash solution are injected into said reactor according to a rising flow.

According to a second alternative, said effluent and said wash solution are injected into said reactor according to a falling flow.

According to a second alternative, said reactor extends along a substantially horizontal axis.

The circulation of liquid can be co-current or counter-current.

Preferably, the device includes at least one liquid eliminator downstream of said reactor.

It is thus possible to remove the droplets from the outgoing gas.

According to an advantageous solution, the device includes means for collecting and re-injecting said wash solution into said reactor.

The invention also includes an installation for treating a gaseous effluent containing odiferous compounds, including a reactor through which said effluent is capable of passing in the presence of a wash solution, characterized in that it includes at least two devices, in each of which said reactor integrates a three-dimensional mesh designed to promote areas of interfacial exchange between said effluent and said wash solution.

The invention also relates to a method for treating a gaseous effluent containing odiferous compounds including a step in which said effluent passes through a reactor in the presence of a wash solution, characterized in that said passage step is achieved by passing said effluent through a three-dimensional mesh integrated in said reactor, which three-dimensional mesh is designed to promote areas of interfacial exchange between said effluent and said wash solution.

Advantageously, said passage step is performed with a speed of said gaseous effluent of between at least 1 m/s and around 30 m/s, and preferably between around 10 m/s and around 20 m/s.

Preferably, the liquid mass flow/gas mass flow ratio is between 0.5 and 15, and preferably between 2 and 10.

This ratio is expressed by (Q_{L}×1000)/(Q_{G}×1.23)] in which Q_{L}=liquid mass flow and Q_{G}=gas mass flow.

Other features and advantages of the invention will become clear on reading the following description of a preferred embodiment of the invention, given by way of an illustrative and non-limiting example, and the appended drawings, in which:

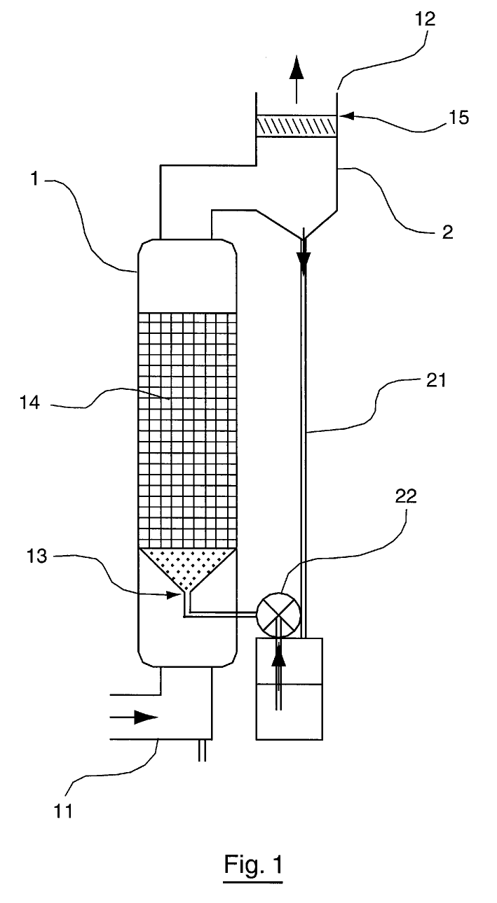

FIG. 1 is a diagrammatic view of a device according to the invention;

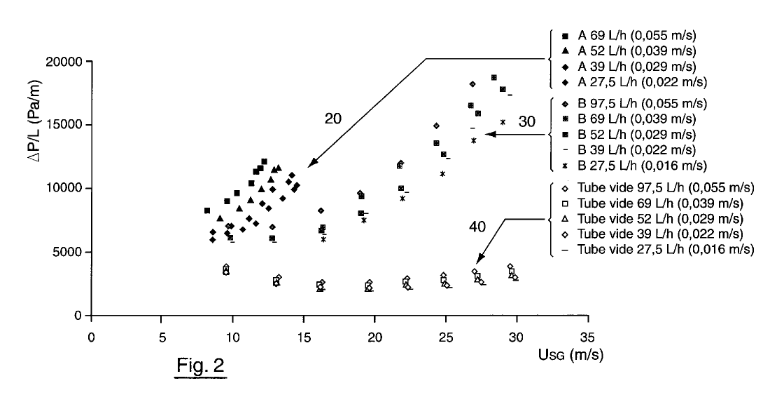

FIG. 2 is a graph of head losses as a function of the gas speed, measured on a device according to the invention, on a static mixer of the prior art and on an empty column;

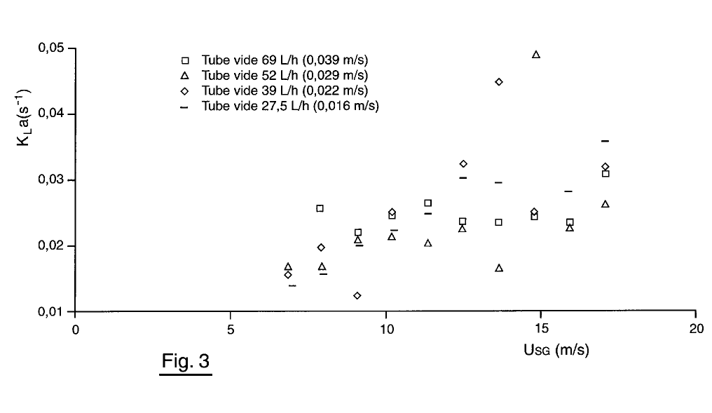

FIGS. 3 to 5 are graphs of head loss measurements, respectively on an empty column, on a static mixer of the prior art and on a device according to the invention;

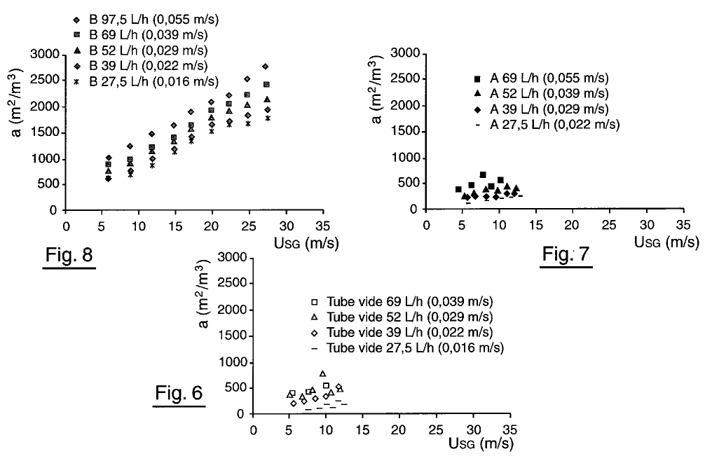

FIGS. 6 to 8 are graphs of interfacial area measurements, respectively on an empty column, on a static mixer of the prior art and on a device according to the invention.

As indicated above, the principle of the invention lies in the integration of a compact cross-linked gas/liquid contactor in the form of a three-dimensional mesh, in a reactor through which a gaseous effluent is capable of passing.

This principle is shown in FIG. 1, which shows a reactor 1 with an inlet 11 for a gaseous effluent, an outlet 12 for said gaseous effluent and means for injecting 13 a wash solution, in which the reactor integrates a three-dimensional mesh 14.

In a manner known per se, the wash solutions are acid, basic and/or oxidizing basic.

The mesh 14 is in the form of a three-dimensional metal or plastic mesh structure (or any other material resistant to the washing liquids used (acids, bases, oxidizing) according to other possible embodiments), 1 cm to 10 cm on each side. The thickness of the strands forming the contact material is between 0.5 and 4 mm in diameter.

For low gas flows (for example below 5,000 m³/h), the meshes will have a size of between 1 cm and 3 cm on each side, while for higher flows, the size of the meshes may be between 3 cm and 10 cm on each side.

In addition, the strands forming the mesh are designed so as to be semi-rigid and are mounted securely on the walls of the reactor 1.

According to the present embodiment, the reactor 1 is in the form of a vertical column, and the gaseous effluent and the solution are injected in a co-current in a rising flow (falling flows and/or counter-current injections can nevertheless be envisaged in other embodiments).

Without going beyond the scope of the invention, it is also possible to design a reactor extending along a horizontal axis.

The device also includes, upstream of the outlet 12 for the treated gaseous effluent, a liquid eliminator 15 removing any droplets of wash solution present in the outgoing gas effluents.

The wash solution is thus collected and recirculated a plurality of times before being replaced, entirely or partially, by a new wash solution.

The droplets separated from the outgoing gas are collected in a sieve 2 that communicates with a duct 21 for re-injection of the collected wash solution, which is coupled to the pump 22 for supplying the reactor with a wash solution.

According to a particular embodiment, an installation for treating gaseous effluents can include a plurality of devices according to the invention mounted in series, which devices operate in a vertical position with rising flows, a vertical position with falling flows, a horizontal position, or in the form of a set of reactors installed in series according to a combination of these various positions.

The method implemented with one or more device(s) such as the one described above therefore consists of causing a gaseous effluent to pass through a reactor integrating a three-dimensional mesh, in the presence of a wash solution.

In such a method, the speed of the gas may range from 1 to 30 m/s, which is considerably higher than on the packed columns according to the prior art (15 times higher) and static mixers (2 to 3 times higher under normal conditions of use). The liquid mass flow/gas mass flow ratio varies between 0.5 and 15 (preferably between 2 and 10). Preferably, the gas speed varies between 10 and 20 m/s.

As shown in the graph of FIG. 2, the head loss observed in a device according to the invention is particularly low by comparison with that observed in a static mixer according to the invention.

This graph indeed shows three groups of measurements:
a group of measurements 20 obtained with a conventional static mixer (A);
a group of measurements 30 obtained with a device according to the invention (B);
a group of measurements 40 obtained with an empty tube (or column) (i.e. in the absence of a structured packing inside the tube).

The comparison of groups 20 and 30 clearly shows that the device according to the invention is advantageous in terms of head losses.

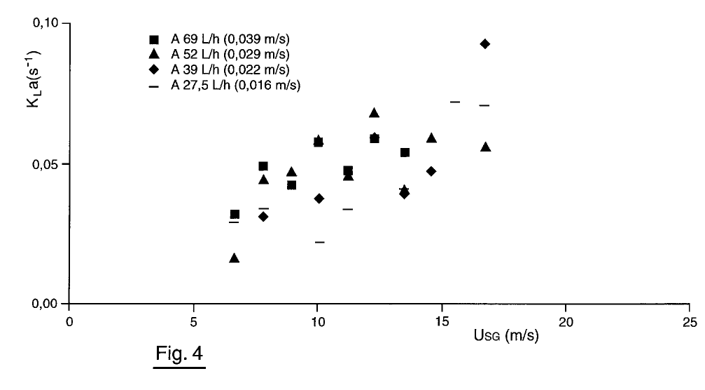

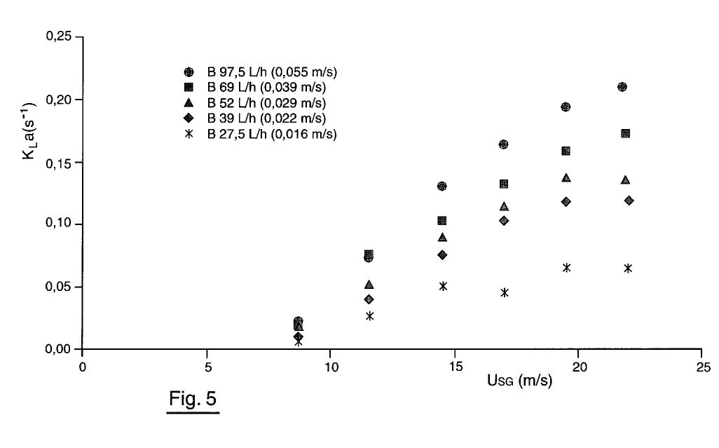

The graphs of FIGS. 3 to 8 make it possible to compare the head loss and the interfacial area (i.e. respectively an increase of K_{L}a and a) as a function of the gas speed with a device according to the invention (FIGS. 5 and 8), an empty column (FIGS. 3 and 6) and a conventional static mixer (FIGS. 4 and 7).

FIGS. 5 and 8 clearly show that the device according to the invention is also particularly advantageous in terms of interfacial area.

FIGS. 2, 3 and 6

| | |
|---|---|
| Tube vide | Empty tube |

1.-19. (canceled)

20. A method for removing odiferous compounds from a gaseous influent the method comprising:
directing gaseous stream into a reactor;
mixing the gaseous stream with a wash solution in the reactor to from a liquid-gas mixture;
directing the liquid-gas mixture through a mesh disposed in the reactor and promoting contact between the gaseous influent and the wash solution in the liquid-gas mixture; and
wherein the contact between the gaseous influent and the wash solution caused by the mesh results in odiferous compounds being removed from the gaseous influent.

21. The method of claim 20 further comprising directing the gaseous influent in the liquid-gas mixture through the reactor at a rate between approximately 1 m/s and approximately 30 m/s.

22. The method of claim 21 further comprising directing the gaseous influent in the liquid-gas mixture through the reactor at a rate between approximately 10 m/s and approximately 20 m/s.

23. The method of claim 20 further comprising directing the wash solution and the gaseous influent in the liquid-gas mixture through the reactor at rate such that the ratio of the rate of wash solution to the rate of gaseous influent is between approximately 0.5 and approximately 15.

24. The method of claim 23 further comprising directing the gaseous influent and the wash solution in the liquid-gas mixture through the reactor at a rate such that the ratio of the rate of wash solution to the rate of gaseous influent is between approximately 2 and approximately 10.

25. The method of claim 20 further comprising directing the gaseous influent and the wash solution in the liquid-gas mixture through the reactor at a rate such that the ratio of the rate of wash solution to the rate of gaseous influent is expressed by the formula (Q_{L}×1000)/(Q_{G}×1.23).

26. The method of claim 20 further comprising:
separating at least a portion of the gaseous influent from the liquid-gas mixture;
directing at least a portion of the gaseous influent from the reactor through a gas outlet;
directing at least a portion of the wash solution from the liquid-gas mixture from the reactor and into a recirculation line; and
directing at least a portion of the wash solution from the recirculation line into the reactor; and
treating the gaseous influent in the reactor with the wash solution from the recirculation line.

27. The method of claim 26 further comprising collecting droplets of the wash solution from the gaseous influent in a liquid collector and directing the droplets into the recirculation line.

28. The method of claim 20 further comprising directing the gaseous influent into the reactor in a counter-current direction relative to the wash solution.

29. The method of claim 20 further comprising treating the gaseous influent with an acidic wash solution and removing odiferous compounds from the gaseous influent.

30. The method of claim 20 further comprising treating the gaseous influent with a basic wash solution and removing odiferous compounds from the gaseous influent.

31. The method of claim 30 further comprising treating the gaseous influent with an oxidizing basic wash solution and removing odiferous compounds from the gaseous influent.

32. The method of claim 20 further comprising:
directing the gaseous influent into the reactor in the same direction as the wash solution;
directing the gaseous influent through the reactor at a rate between approximately 10 m/s and approximately 20 m/s;
directing the wash solution and the gaseous influent through the reactor at rate such that the ratio of the rate of wash solution to the rate of gaseous influent is between approximately 2 and approximately 10;
separating at least a portion of the wash solution from the gaseous influent with a liquid eliminator; and
collecting the wash solution separated from the gaseous influent in a liquid collector and directing the wash solution into the recirculation line.

33. A system for removing odiferous compounds from a gaseous influent comprising:
a reactor for treating the gaseous influent with a wash solution;
an inlet for directing the gaseous stream into the reactor;
an inlet for directing the wash solution into the reactor;
a mesh disposed within the reactor for promoting contact between the gaseous influent and the wash solution;
the mesh extending a substantial length through the reactor and including a plurality of interconnected strands that form an array of openings;
a liquid eliminator disposed downstream of the reactor to separate the wash solution from the gaseous influent;
a liquid collector disposed below the liquid eliminator to receive and hold wash solution separated from the gaseous influent by the liquid eliminator;
an outlet disposed downstream from the liquid eliminator to direct treated gaseous influent from the reactor; and
a recirculation line extending outside the reactor to recirculate the wash solution.

34. The system of claim 33 wherein each of the plurality of strands has a circular cross-section and a diameter of between approximately 0.5 mm and approximately 4 mm.

35. The system of claim 34 wherein the strands are semi-rigid.

36. The system of claim 33 wherein the mesh includes openings having a length of between approximately 1 cm and approximately 10 cm.

37. The system of claim 36 wherein the mesh includes openings having a length of between approximately 1 cm and approximately 3 cm.

38. A system for removing odiferous compounds from a gaseous influent comprising:
a reactor for treating the gaseous influent with a wash solution;
an inlet for directing the gaseous stream into the reactor;
an inlet for directing the wash solution into the reactor;
a mesh disposed within the reactor for promoting contact between the gaseous influent and the wash solution; and
the mesh extending a substantial length through the reactor and including a plurality of interconnected strands that form an array of openings.

39. The method of claim 38 further comprising:
a liquid eliminator disposed downstream of the reactor to separate the wash solution from the gaseous influent;
a liquid collector disposed below the liquid eliminator to receive and hold wash solution separated from the gaseous influent by the liquid eliminator; and
a recirculation line extending outside the reactor to recirculate the wash solution.
